(19) United States
(12) Patent Application Publication
(10) Pub. No.: US 2011/0149273 A1
(43) Pub. Date: Jun. 23, 2011

(54) METHOD AND SYSTEM FOR MEASURING A FOCAL LENGTH OF AN OPTICAL LENS

(75) Inventors: CHAO-YI YEH, Chu-Nan (TW); CHUNG-CHIH HUANG, Chu-Nan (TW); RONG-YIH YAN, Chu-Nan (TW)

(73) Assignee: FOXSEMICON INTEGRATED TECHNOLOGY, INC., Chu-Nan (TW)

(21) Appl. No.: 12/849,753

(22) Filed: Aug. 3, 2010

(30) Foreign Application Priority Data
Dec. 21, 2009 (CN) 200910311948.8

(51) Int. Cl. G01M 11/02

(52) U.S. Cl. 356/125

(57) ABSTRACT

A system for measuring a focal length of an optical lens includes an image processing device and an operating platform. The image processing device is configured for capturing a light spot image of the optical lens. The operating platform includes a mount, a holder and a measurer. The mount is configured for mounting the image processing device. The holder is configured for holding the optical lens. The mount is moved back and forth along the direction towards and away from the optical lens held by the holder. The measurer is configured for measuring and recording a distance between image processing device and the optical lens when a minimal light spot image of the optical lens is obtained. The distance is the focal length of the optical lens.

### CROSS-REFERENCE TO RELATED APPLICATIONS

This application is related to patent application Ser. No. ______, entitled “METHOD AND SYSTEM FOR EVALUATING LIGHT UNIFORMITY THROUGH AN OPTICAL LENS” and filed on ______, 2010 (Attorney Docket No. US30296). Such application has the same inventors and assignee as the present application.

### BACKGROUND

1. Technical Field

The disclosure relates generally to lenses, and more particularly to a method and a system for measuring characters of the lens.

2. Description of the Related Art

An optical lens utilized to condense solar light is a major way to increase the efficiency of a solar cell. Normally, a microscope measures characters of the optical lens, which increase production cost accordingly. Thus, what is called for is a system and a method for measuring characters of an optical lens that can overcome the disadvantage described.

### BRIEF DESCRIPTION OF THE DRAWINGS

FIG. 1 is an isometric view of a system for measuring a focal length of an optical lens in accordance with a first embodiment of the disclosure.

FIG. 2 is a flowchart of a method for utilizing the system for measuring a focal length of an optical lens of FIG. 1 in accordance with the first embodiment of the disclosure.

FIG. 3 is an isometric view of a system for measuring a focal length of an optical lens in accordance with a second embodiment of the disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

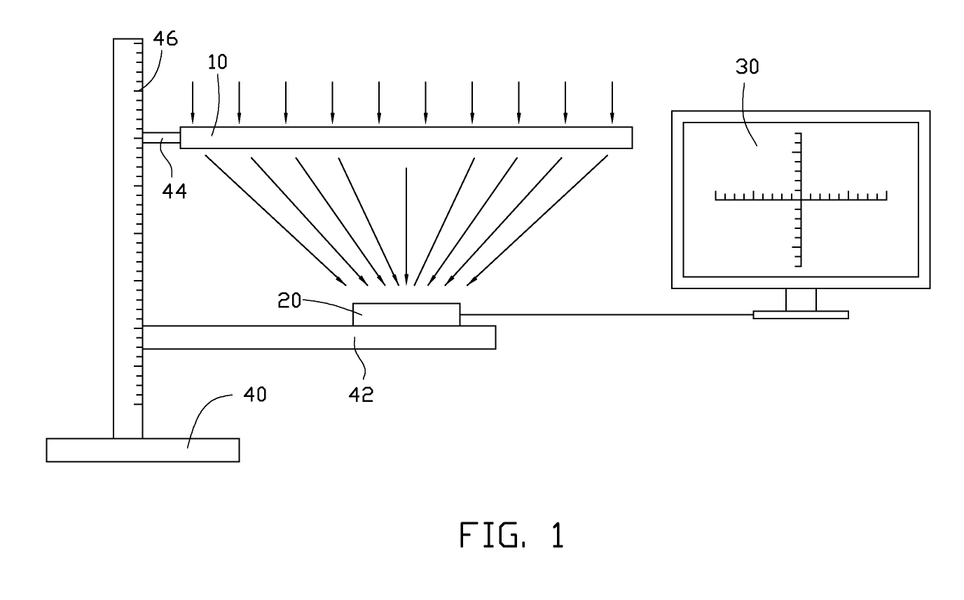

Referring to FIG. 1, a system for measuring characters of an optical lens in accordance with a first embodiment of the disclosure is utilized to measure a focal length of an optical lens 10. The optical lens 10 in accordance with the disclosure is a Fresnel lens.

The system for measuring a focal length of optical lens 10 includes an image processing device 20, a display device 30 and an operating platform 40.

The displaying device 30 is electrically coupled to the image processing device 20. The image processing device 20 includes a charge coupled device camera sensor (CCD camera sensor) or a complementary metal-oxide semiconductor camera sensor (CMOS camera sensor). The image processing device 20 is configured for capturing an image of a light spot corresponding to the optical lens 10 and transmitting the image of the light spot to the display device 30. The display device 30 is configured for displaying the image of the light spot.

The operating platform 40 includes a mount 42 and a holder 44. The mount 42 is configured for mounting the image processing device 20. The holder 44 is configured for holding the optical lens 10. The operating platform 40 is configured for controlling the mount 42 to move back and forth along the direction towards and away from the optical lens 10. Thus, the size of image on the display device 30 is variable. A ruler 46 is defined in the path that the mount 42 is moved back and forth on. When a minimal light spot image is obtained, the measurement of the ruler 46 is the actual focal length of the optical lens 10.

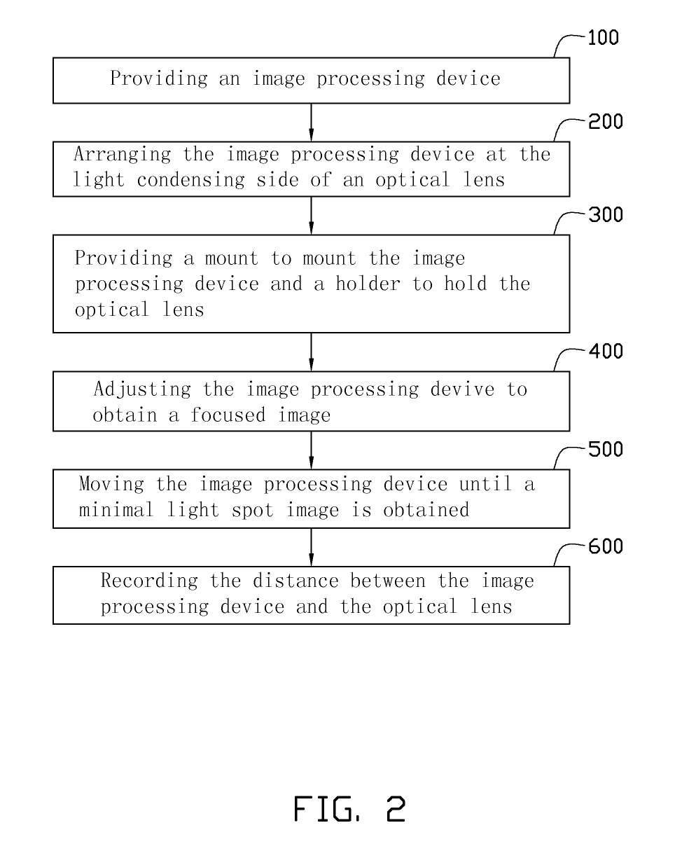

Referring to FIG. 2, is a flowchart of a method for utilizing the system for measuring a focal length of an optical lens 10 in accordance with the first embodiment of the disclosure.

In block 100, the image processing device 20 and the display device 30 are provided. The display device 30 is electrically coupled to the image processing device 20.

In block 200, the imaging processing device 20 is arranged at the light condensing side of the optical lens 10. The image processing device 20 is configured for capturing the image of the light spot of the optical lens 10.

The image processing device 20 can be arranged at a design value of a focal length F of the optical lens 10.

In block 300, the mount 42 of the operating platform 40 and the holder 44 thereof are provided. The mount 42 is configured for mounting the imaging processing device 20. The holder 44 is configured for holding the optical lens 10. The mount 42 is configured for being moved back and forth along the direction towards and away from the optical lens held by the holder 44.

In block 400, the image processing device 20 is adjusted until a focused image is obtained. The adjusting process can be realized by adjusting resolution of image.

In block 500, the image processing device 20 is moved back and forth along a direction towards and away from the optical lens 10 until a minimal light spot image of the optical lens 10 is obtained by the image processing device 20. The display device 30 can show the simultaneous measurement of the ruler 46.

In block 600, a distance D between the image processing device 20 and the optical lens 10 is recorded. When the intensity of the light spot is highest and the size thereof is minimal, the image processing device 20 is shifted to the actual focal point of the optical lens 10. Thus, the distance D between the image processing device 20 and the optical lens 10 is the actual focal length of the optical lens 10.

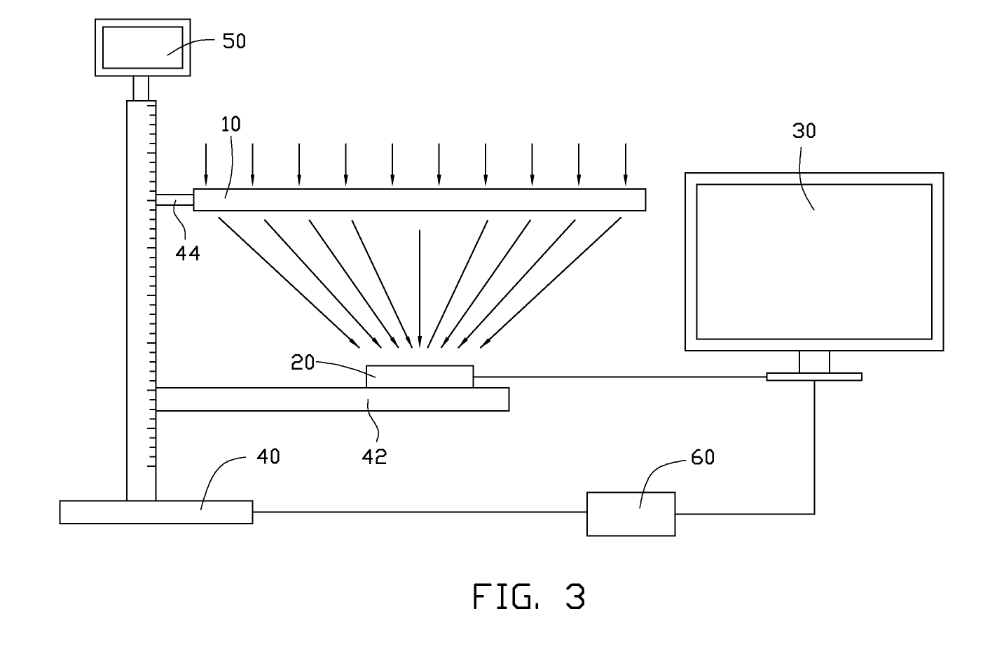

Referring to FIG. 3, a system for measuring a focal length of an optical lens 10 in accordance with a second embodiment is similar to the system in accordance with the first embodiment in FIG. 1. The system in accordance with the second embodiment in FIG. 3, differs only in the fact that it further includes an electronic measurer 50 and a comparator 60. The comparator 60 is electrically connected to the operating platform 40 and display device 30. The electronic measurer 50 is configured for automatically measuring the distance between the image processing device 20 and the optical lens 10. When the minimal light spot image is captured by the image processing device 20, the electronic measurer 50 can show the actual distance value.

When the mounting part 42 is shifted back and forth, the image processing device 20 can capture several light spot images corresponding to the different distances between the image processing device 20 and the optical lens 10. The comparator 60 is configured for comparing sizes of the light spots. When the comparator 60 selects a minimal light spot image, the comparator 60 provides a signal to the electronic measurer 50. The electronic measurer 50 can record and show the distance D between the image processing device 20 and the optical lens 10 according to the signal from the comparator 60. Thus, the distance D between the image processing device 20 and the optical lens 10 is the actual focal length of the optical lens 10. The comparator 60 can be a physical device or a software code module executed in the computer.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for measuring a focal length of an optical lens comprising:
an image processing device configured for capturing a light spot image of the optical lens; and
an operating platform comprising a mount, a holder and a measurer, the mount configured for mounting the image processing device, the holder configured for holding the optical lens, the mount moved back and forth along the direction towards and away from the optical lens held by the holding part, the measurer configured for measuring and recording a distance between image processing device and the optical lens when a minimal light spot image of the optical lens is obtained.

2. The system for measuring a focal length of an optical lens as claimed in claim 1, wherein the image processing device comprises a charge coupled device image sensor.

3. The system for measuring a focal length of an optical lens as claimed in claim 1, wherein the image processing device comprises a complementary metal-oxide semiconductor image sensor.

4. The system for measuring a focal length of an optical lens as claimed in claim 1, wherein the image processing device further comprises a displaying device electrically connected thereto, the displaying device configured for showing the light spot image of the optical lens captured by the image processing device.

5. The system for measuring a focal length of an optical lens as claimed in claim 1 further comprising a comparator, the comparator configured for providing a signal to the measurer when the minimal light spot image is obtained by the image processing device, the measurer measuring and recording the distance between the optical lens and the image processing device according to the signal from the comparator.

6. A method for measuring a focal length of an optical lens comprising:
providing an image processing device;
arranging the image processing device at a light condensing side of the optical lens;
providing a mount of an operating platform to mount the image processing device and a holder thereof to hold the optical lens, the mount moved back and forth along the direction towards and away from the optical lens held by the holding part;
obtaining a light spot image;
moving the mount back and forth until a minimal light spot image is obtained by the image processing device; and
providing a measurer to record the distance between the image processing device and the optical lens.

7. The method for measuring a focal length of an optical lens as claimed in claim 6, wherein the image processing device comprises a charge coupled device image sensor.

8. The method for measuring a focal length of an optical lens as claimed in claim 6, wherein the image processing device comprises a complementary metal-oxide semiconductor image sensor.

9. The method for measuring a focal length of an optical lens as claimed in claim 6, further comprising:
providing a displaying device electrically connected to the image processing device to show the light spot image of the optical lens.

10. The method for measuring a focal length of an optical lens as claimed in claim 6, further comprising:
providing a comparator to provide a signal to the measurer when the minimal light spot image is obtained by the image processing device, and
recording the distance between the image processing device and the optical lens according to the signal from the comparator.

11. A method for measuring a focal length of a Fresnel lens comprising:
providing an image processing device;
arranging the image processing device at a light condensing side of the Fresnel lens;
moving the image processing device back and forth along the direction towards and away from the Fresnel lens to obtain a plurality of light spot images by the image processing device;
obtaining a minimal light spot image by the image processing device; and
recording a distance between the image processing device and the Fresnel lens to be the focal length of the Fresnel lens when the minimal light spot image is obtained.

12. The method for measuring a focal length of a Fresnel lens as claimed in claim 11, wherein the image processing device comprises a charge coupled device image sensor.

13. The method for measuring a focal length of a Fresnel lens as claimed in claim 11, wherein the image processing device comprises a complementary metal-oxide semiconductor image sensor.

14. The method for measuring a focal length of a Fresnel lens as claimed in claim 11, further comprising showing the minimal light spot image in a display.

15. The method of measuring a focal length of a Fresnel lens as claimed in 14, further comprising showing the focal length of the Fresnel lens in an electronic measurer.
